(19) United States
(12) Patent Application Publication
(10) Pub. No.: US 2025/0385240 A1
(43) Pub. Date: Dec. 18, 2025

(54) METHOD FOR MANUFACTURING ELECTRODE FOR ALL-SOLID STATE BATTERY, ELECTRODE FREE STANDING MEMBRANE, ELECTRODE, AND ALL-SOLID STATE BATTERY INCLUDING THE SAME

(71) Applicants: Hyundai Motor Company, Seoul (KR); Kia Corporation, Seoul (KR)

(72) Inventors: Ju Yeon Lee, Hwaseong (KR); Gyeong Jun Chung, Hwaseong (KR); Min Sun Kim, Hwaseong (KR); So Ri Lee, Hwaseong (KR); Seung Hwan Moon, Hwaseong (KR); Seul Gi Choi, Hwaseong (KR); Young Jin Nam, Hwaseong (KR); Jong Jung Kim, Hwaseong (KR)

(21) Appl. No.: 18/939,151

(22) Filed: Nov. 6, 2024

(30) Foreign Application Priority Data
Jun. 18, 2024 (KR) 10-2024-0079140

(51) Int. Cl. H01M 4/04; H01M 4/02; H01M 4/62

(52) U.S. Cl. CPC H01M 4/0407; H01M 4/0435; H01M 4/623; H01M 2004/028

(57) ABSTRACT

Provided are a method for dry-manufacturing an electrode for an all-solid state battery, an electrode free standing membrane prepared through the manufacturing method, an electrode, and an all-solid state battery including the same. This dry process eliminates solvents, making it environmentally friendly and efficient. The method involves forming an electrode active material complex by mixing the active material with a solid electrolyte, combining it with a conductive material and binder, and then rolling the mixture into an electrode film. The film is bonded to a current collector, ensuring strong adhesion and mechanical stability. The free-standing membrane enhances ion and electron conductivity, improving overall battery performance. The resulting all-solid-state battery offers higher energy density, longer cycle life, and increased safety, making it well-suited for electric vehicles, portable electronics, and advanced energy storage applications.

### CROSS-REFERENCE TO RELATED APPLICATION

This application claims the benefit of Korean Patent Application No. 10-2024-0079140, filed in the Korean Intellectual Property Office on Jun. 18, 2024, the entire contents of which are incorporated herein by reference.

### TECHNICAL FIELD

The present disclosure relates to a method for dry-manufacturing an electrode for an all-solid state battery. More specifically, it describes a method capable of first preparing an electrode active material complex by using an electrode active material and a solid electrolyte, then mixing the electrode active material complex and a binder, and performing a needing process for the mixture. This process enhances the uniformity of a shear stress applied to the mixture during the needing process, enabling the manufacture of an efficient electrode for an all-solid-state battery while using a reduced amount of binder.

In addition, the present disclosure provides an electrode free standing membrane formed through this method, along with an electrode and an all-solid state battery including the same.

### BACKGROUND

Recently, studies and researches have been performed on various batteries capable of overcoming the limitation of a lithium secondary battery in terms of a capacity, stability, or power of the lithium secondary battery, and the limitations in expanding or compacting the secondary battery. Among this, an all-solid state battery, which refers to a battery having a solid electrolyte substituted for an electrolyte used for an existing lithium secondary battery, has no risk of fire or explosion resulting from the decomposition reaction of an existing electrolyte, because the all-solid state battery does not employ a solvent having flammability inside the all-solid state battery. Accordingly, the all-solid state battery may be significantly improved in stability.

An electrode used for the all-solid state battery may be representatively manufactured through a dry-manufacturing manner and a wet-manufacturing manner. According to the wet-manufacturing manner, the electrode is manufactured similarly to a method for manufacturing a lithium secondary battery generally known to those skilled in the art. According to the wet-manufacturing manner, solid electrolyte particles are contained in electrode slurry, and are contained in one electrode layer together with electrode active material particles in processes of applying the slurry to a current collector and drying the result. The wet-manufacturing manner allows various materials contained in the electrode layer to be uniformly mixed. However, the electrode for the all-solid state battery manufactured through the wet-manufacturing manner may be degraded in uniformity, as the electrode for the all-solid state battery becomes thicker, and may essentially require the drying process to remove the solvent from the slurry, thereby causing the increase the costs for the manufacturing process.

Meanwhile, according to the dry-manufacturing manner, after an electrode active material, a binder, a conductive material, and particles of a solid electrolyte are mixed together in a solid status without a solvent, the mixture is manufactured in the form of an electrode without change. For example, shear stress is applied to the mixture to change the mixture to be in clay-like status. Then, a film may be directly formed on a surface of the mixture by performing a rolling process the mixture in the clay-like status. An electrode film formed in such a manner is bound with a current collector thereby manufacturing the electrode. According to the dry-manufacturing manner, since a solvent is not used, an additional dry process is not required, which reduce the process costs.

However, the electrode active material, the binder, and the solid electrolyte, which are mixed with each other in the dry-manufacturing manner, have different particle sizes. Accordingly, the important issue is to enhance the uniformity of the shear stress applied in the process of changing the mixture to be in a clay-like status. When the particles contained in the mixture have different sizes, different shear stress is applied for each particle, which serves as an obstacle in manufacturing a uniform electrode. To overcome the above problem, the particle size of the binder having a larger particle size may be considered reduced. However, to reduce the particle size of the binder, a molecular weight of the binder needs to be lowered. However, the binder having the lowered molecular weight may be difficult to be fiberized.

Accordingly, there is required to a novel manufacturing method to enhance the uniformity of an electrode manufactured, in the method for dry-manufacturing the electrode for the all-solid state battery.

### SUMMARY

The present disclosure has been made to solve the above-mentioned problems occurring in the prior art while advantages achieved by the prior art are maintained intact.

An aspect of the present disclosure provides a method for manufacturing an electrode for an all-solid state battery, an electrode free standing membrane formed in the method for manufacturing the electrode, an electrode, and the all-solid state battery including the electrode.

Another aspect of the present disclosure provides a method for manufacturing an electrode for an all-solid state battery, in which an electrode active material complex is first prepared in the form of coating a solid electrolyte on the surface of an electrode active material, and mixed with a binder, and the mixture is changed to be in a clay-like status, thereby minimizing the irregular shear stress resulting from the difference in particle size among the electrode active material, the solid electrolyte, and the binder, such that the uniform electrode for the all-solid state battery is prepared using even a smaller amount of binder, an electrode free standing membrane formed during the above process, the electrode, and the all-solid state battery including the electrode.

The technical problems to be solved by the present disclosure are not limited to the aforementioned problems, and any other technical problems not mentioned herein will be clearly understood from the following description by those skilled in the art to which the present disclosure pertains.

To solve the problem, the present disclosure provides a method for manufacturing an electrode for an all-solid state battery, an electrode free standing membrane, an electrode, and an all-solid state battery.

(1) More specifically, the present disclosure provides a method for manufacturing an electrode for an all-solid state battery, which includes preparing an electrode active material complex by mixing an electrode active material with a solid electrolyte (S1), preparing a mixture by mixing the electrode active material complex, a conductive material, and a binder (S2), forming an electrode film by performing rolling the mixture in a clay status (S3), and binding a current collector with the electrode film (S4), in which a ratio (D2/D1) between an average particle size (D1) of the electrode active material complex and an average particle size (D2) of the binder is at most 20.

(2) The present disclosure provides the method for manufacturing the electrode for the all-solid state battery, in which the electrode active material complex is prepared by coating a solid electrolyte shell on an electrode active material core, and a ratio (b/a) between a diameter (a) of the electrode active material core and a thickness (b) of the solid electrolyte shell ranges from 0.05 to 0.5 in (1).

(3) The present disclosure provides the method for manufacturing the electrode for the all-solid state battery, in which an average particle size of the electrode active material ranges from 1 μm to 50 μm in (1) or (2).

(4) The present disclosure provides the method for manufacturing the electrode for the all-solid state battery, in which an average particle size of the solid electrolyte ranges from 0.01 μm to 20 μm in any one of (1) to (3).

(5) The present disclosure provides the method for manufacturing the electrode for the all-solid state battery, in which an average particle size of the binder is at most 500 μm in any one of (1) to (4).

(6) The present disclosure provides the method for manufacturing the electrode for the all-solid state battery, in which the binder comprises polytetrafluoroethylene (PTFE) or polyvinylidene fluoride-hexapropylene (PVDF-HFP) copolymer in any one of (1) to (4).

(7) The present disclosure provides the method for manufacturing the electrode for the all-solid state battery, in which a content of the binder in the electrode is at most 5 wt % in any one of (1) to (6).

(8) The present disclosure provides the method for manufacturing the electrode for the all-solid state battery, in which the S1 and S2 are performed in absence of a solvent in any one of (1) to (7).

(9) The present disclosure provides the method for manufacturing the electrode for the all-solid state battery, in which the S2 includes changing the mixture to be clay-like by performing a needing process for the mixture in any one of (1) to (7).

(10) The present disclosure provides the method for manufacturing the electrode for the all-solid state battery, in which the rolling process is performed using a primary roller and a secondary roller in any one of (1) to (9).

(11) The present disclosure provides the method for manufacturing the electrode for the all-solid state battery, in which a roll speed ratio of the primary roller ranges from 1:0.05 to 1:5 in any one of (1) to (9)

(12) The present disclosure provides the method for manufacturing the electrode for the all-solid state battery, in which a roll speed ratio of the secondary roller ranges from 1:5 to 1:15 in any one of (1) to (11).

(13) The present disclosure provides the method for manufacturing the electrode for the all-solid state battery, in which a stretching speed in the S3 is at most 20 mm/min in any one of (1) to (12).

(14) The present disclosure provides the method for manufacturing the electrode for the all-solid state battery, in which the S3 is performed at a temperature ranging from 50° C. to 90° C. in any one of (1) to (13).

(15) The present disclosure provides the method for manufacturing the electrode for the all-solid state battery, in which the electrode is a positive electrode in any one of (1) to (14).

(16) The present disclosure provides an electrode free standing membrane including an electrode active material complex including an electrode active material and a solid electrolyte, a binder, and a conductive material, in which a ratio (D2/D1) between an average particle size (D1) of the electrode active material complex and an average particle size (D2) of the binder is at most 20.

(17) The present disclosure provides the electrode free standing membrane in which the electrode active material complex is prepared by coating a solid electrolyte shell on an electrode active material core, and a ratio (b/a) between a diameter (a) of the electrode active material core and a thickness (b) of the solid electrolyte shell ranges from 0.05 to 0.5 in (16).

(18) The present disclosure provides an electrode including an electrode free standing membrane in (16) or (17), and a current collector.

(19) The present disclosure provides the electrode in which the electrode is a positive electrode.

(20) The present disclosure provides an all-solid state battery including an electrode according to (18) or (19), an opposite electrode, and a solid electrolyte layer interposed between the electrode and the opposite electrode.

(21) The present disclosure provides an electrode free standing membrane. The membrane comprises an electrode active material complex including: an electrode active material core and a solid electrolyte on the electrode active material core. The membrane further comprises a binder and a conductive material. A ratio (b/a) between a diameter (a) of the electrode active material core and a thickness (b) of the solid electrolyte shell ranges from about 0.05 to 0.5.

(22) As discussed, the method and system suitably include use of a controller or processer.

(23) In another embodiment, vehicles are provided that comprise an apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is an SEM image illustrating an electrode film prepared according to Embodiment 1; and

FIG. 2 is an SEM image illustrating an electrode film prepared according to Comparative example 2.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other clements. In addition, the terms “unit”, “-er”, “-or”, and “module” described in the specification mean units for processing at least one function and operation, and can be implemented by hardware components or software components and combinations thercof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure will be described in more detail.

In this case, terms and words used in the present specification and the claims shall not be limitedly interpreted as commonly-used dictionary meanings, but shall be interpreted as to be relevant to the technical scope of the present disclosure based on the fact that the inventor may properly define the concept of the terms to explain the present disclosure in best ways.

### Method for Manufacturing Electrode for All-Solid State Battery

The present disclosure provides a method for manufacturing an electrode for an all-solid state battery including preparing an electrode active material complex by mixing an electrode active material with a solid electrolyte (S1), preparing a mixture by mixing the electrode active material complex, a conductive material, and a binder (S2), forming an electrode film by performing rolling the mixture in a clay status (S3), and binding a current collector with the electrode film (S4), in which the ratio (D2/D1) between an average particle size (D1) of the electrode active material complex and an average particle size (D2) of the binder is at most 20.

According to the method for dry-manufacturing the electrode for the all-solid state battery, the shear stress may be irregularly applied in the process of changing the mixture to be in the clay-like status, due to the difference in particle size between the binder and the electrode active material. According to the present disclosure, the solid electrolyte is coated on the surface of the electrode active material, thereby preparing an electrode active material complex having a larger size. The electrode active material complex and the binder are mixed and subject to a needing process, thereby minimizing the irregular shear stress.

Hereinafter, the method for manufacturing the electrode for the all-solid state battery will be described in more detail.

### Preparing (S1) of Electrode Active Material Complex

According to the present disclosure, an electrode active material complex is prepared by first mixing an electrode active material with a solid electrolyte, which differs from a conventional method for dry-manufacturing the electrode for the all-solid state battery, in which, after mixing all an electrode active material, a conductive material, a binder, and a solid electrolyte together, the mixture is changed to be in a clay-like status.

When the electrode active material complex is prepared as described above, solid electrolyte particles are coated on the surface of the electrode active material, and the particle size of the electrode active material complex becomes larger than that of the electrode active material to reduce the difference in particle size from the binder having a larger size. Accordingly, even the solid electrolyte is uniformly distributed on the surface of an active material particle, thereby enhancing the uniformity of the solid electrolyte in the electrode.

More specifically, the electrode active material complex is prepared in the present step by coating a solid electrolyte shell on an electrode active material core. The ratio (b/a) between the diameter (a) of the electrode active material core and the thickness (b) of the solid electrolyte shell may range from 0.05 to 0.5. More preferably, the ratio (b/a) may be at least 0.1, at least 0.15, at least 0.20, or at least 0.25, and at most 0.45, at most 0.40, or at most 0.30. When the ratio (b/a) is excessively low, the solid electrolyte is not sufficiently coated on the surface of the electrode active material, so the particle size of the electrode active material complex is not sufficiently increased. Accordingly, the irregular shear stress resulting from the difference in particle size from the binder may not be sufficiently resolved, and a uniform electrode film may not be formed. On the contrary, when the value of the ratio (b/a) is excessively high, as an excessively large amount of solid electrolyte is coated, the electrode active material complex may not be easily prepared.

The electrode active material employed in the present step may be a positive electrode active material or a negative electrode active material, and more preferably, may be the positive electrode active material. The average particle size (D₅₀) may range from 1 μm to 50 μm. More preferably, the average particle size (D50) may be at least 1 μm, at least 2 μm, or at least 3 μm, and at most 45 μm, at most 40 μm, at most 35 μm, at most 30 μm, at most 25 μm, at most 20 μm, at most 15 μm, at most 10 μm, or at most 7 μm. In addition, the density of the electrode active material may range from 1 g/cm³ to 10 g/cm³. Preferably, the density of the electrode active material may be at least 1.5 g/cm³ or at least 2 g/cm³, and at most 8 g/cm³, at most 5 g/cm³ or at most 3 g/cm³.

The electrode active material may include a positive electrode active material or a negative electrode active material which is typically employed for the electrode for the all-solid state battery, and the type of the active material is not particularly limited thereto.

More specifically, the positive electrode active material may include an oxide active material or a sulfide active material.

The oxide active material may be a rock salt-layer-type active material, such as LiCoO₂, LiMnO₂, LiNiO₂, LiVO₂, Li₁₊ₓNi_{1/3}Co_{1/3}Mn_{1/3}O₂, or Li[NiₓCo_{y}Mn_{z}Mv]O₂ (in the above formula, ‘M’ is any one or at least two types of elements selected from the group consisting of transition metals including Al, Ga, and In; 0.3 Åx<1.0, 0≤y, z≤0.5, 0≤v≤0.1, and x+y+z+v=1), a spinel-type active material, such as LiMn₂O₄, Li(Ni_{0.5}Mn₁₅)O₄, a reverse spinel-type active material, such as LiNiVO₄ or LiCoVO₄, an olivine-type active material such as LiFePO₄, LiMnPO₄, LiCoPO₄, LiNiPO₄, a silicon-containing active material, such as Li₂FeSiO₄ or Li₂MnSiO₄, rock salt-layer-type active material, such as LiNi_{0.8}Co(_{0.2-x})AlₓO₂ (0<x<0.2), which is obtained by substituting a portion of transition metal into heterogeneous metal, a spinel-type active material, such as Li₁₊ₓMn_{2-x-y}M_{y}O₄ (‘M’ is at least one of Al, Mg, Co, Fe, Ni, and Zn, and 0<x+y<2), obtained by substituting a portion of transition metal into heterogeneous metal, or lithium titanate such as Li₄Ti₅O₁₂. The sulfide active material may be copper Chevrel, iron sulfide, cobalt sulfide, or nickel sulfide.

Meanwhile, the negative electrode active material may be a carbon active material or a metal active material.

The carbon active material may be graphite such as mesocarbon microbeads (MCMB), or highly oriented graphite (HOPG), or amorphous carbon such as hard carbon and soft carbon. The metal active material may be In, Al, Si, Sn, and the alloy containing at least one of In, Al, Si, or Sn.

The solid electrolyte employed in the present step may be used without specific limitation, as long as the solid electrolyte is used for the all-solid state battery. More specifically, the solid electrolyte may be an oxide-based solid electrolyte or a sulfide-based solid electrolyte. Preferably, the solid electrolyte may be the sulfide-based solid electrolyte. The solid electrolyte may have lithium ion conductivity of at least 0.3 ms/cm.

Although the sulfide-based solid electrolyte is not particularly limited thereto, the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O-LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (‘m’ and ‘n’ are positive numbers, and ‘Z’ is one of Ge, Zn, and Ga), Li₂S—GeS₂, Li₂S—SiS₂—Li₃PO₄, Li₂S—SiS₂—LiₓMO_{y} (‘x’ and ‘y’ are a positive number, ‘M’ is one of P, Si, Ge, B, Al, Ga, and In), or Li₁₀GeP₂S₁₂.

The average particle size (D₅₀) of the solid electrolyte may range from 0.01 μm to 20 μm. Preferably, the average particle size of the solid electrolyte may be at least 0.05 μm, at least 0.1 μm or at least 0.5 μm, and at most 10 μm, at most 5 μm, or at most 3 μm. In addition, the density of the solid electrolyte may range from 0.01 g/cm³ to 5 g/cm³. Preferably, the density of the solid electrolyte may be at least 0.2 g/cm³, at least 0.3 g/cm³, and at most 3 g/cm³, at most 1 g/cm³ or at most 0.7 g/cm³.

### Changing (S2) of Mixture to be Clay-Like

The mixture may be prepared by mixing the electrode active material, the conductive material, and the binder obtained through the above step. In the present step, as the binder is fiberized, the electrode active material complex, the conductive material, and the binder may be bound with each other. In particular, the present step may further include performing a needing process for the mixture and changing the mixture to be in the clay-like status for more efficient fiberization.

Meanwhile, the ratio (D2/D1) between the average particle size (D1) of the electrode active material complex prepared in the present step and the average particle size (D2) of the binder may be at most 20. Preferably, the ratio (D2/D1) may be at least 1, at least 2, at least 3, or at least 5, and at most 20, at most 18, at most 16, or at most 10. When the ratio (D2/D1) between the average particle size of the electrode active material complex and the average particle size of the binder is excessively high, the size of the electrode active material complex fails to sufficiently approximate to the size of the binder, the irregular shear stress resulting from the difference in size between the two components may not be resolved. Meanwhile, the values of ‘D1’ and ‘D2’ may refer to values of ‘D50’ for the particles. In addition, in the present disclosure, the value of ‘D50’ may refer to the diameter of a particle having an accumulated volume of 50 volume % in particle distribution.

The binder employed in the present step may be polytetrafluorocthylene (PTFE) or polyvinylidene fluoride-hexapropylene (PVDF-HFP) copolymer. Preferably, the binder may be polytetrafluoroethylene. The binder employed in the present disclosure may be employed without a specific limitation, as long as the binder is a binder which can be fiberized to be used to prepare a dried composition. The listed binder components may strongly bind the electrode active material complex with the conductive material without the use of a solvent.

The average particle size of the binder may be at most 500 μm. Preferably, the average particle size of the binder may be at least 50 μm, at least 100 μm, at least 150 μm, and at most 400 μm, at most 350 μm, at most 300 μm, or at most 250 μm. In addition, the density of the binder may range from 0.1 g/cc to 10 g/cc. Preferably, the density of the binder may be at least 0.3 g/cc or at least 1 g/cc and at most 8 g/cc, 5 g/cc, or 3 g/cc.

The conductive material employed in the present step may be a point-type conductive material or a linear-type conductive material. More specifically, the conductive material may be carbon black, conducting graphite, ethylene black, graphene, or carbon nanotube. The average density of the conductive material may range from 0.1 g/cc to 5 g/cc. Preferably, the average density of the conductive material may be at least 0.15 g/cc or at least 0.2 g/cc, and at most 4 g/cc or at most 3 g/cc.

The content of the binder employed in the present step may be at most 5 wt % inside the electrode film. More specifically, the content of the binder may be at most 5 wt %. Preferably, the content of the binder may be at most 4 wt %, at most 3 wt %, at most 2 wt %, or at most 1.5 wt %, and at least 0.01 wt %, at least 0.1 wt %, or at least 0.5 wt %, based on the sum of the weights of the electrode active material, the solid electrolyte, and the binder. The usage of the binder is significantly small, as compared to that of the method for dry-manufacturing the all-solid state battery. Accordingly, when the conventional method is employed, the electrode film may be stably formed only when the content of the binder is at least 10 wt %. On the contrary, according to the present disclosure, the electrode active material complex is prepared and mixed with the binder. Accordingly, the electrode film may be stably formed by using even a smaller amount of binder. When the smaller amount of binder is used, even the resistance of the electrode is decreased, which exhibits the excellent performance of the electrode.

For the mixture prepared through the present step, the proportion of the electrode active material in the mixture may range from 60 wt % to 99 wt %. Preferably, the proportion of the electrode active material may be at least 70 wt % and at most 95 wt %. In addition, the proportion of the solid electrolyte in the mixture may range from 1 wt % to 40 wt %. Preferably, the proportion of the solid electrolyte in the mixture may range from 5 wt % to 30 wt %. In addition, the proportion of the conductive material in the mixture may range from 0.1 wt % to 5 wt %. Preferably, the proportion of the conductive material may range from 0.2 wt % to 3 wt %.

The present step and the S1 described above may be performed in the absence of a solvent.

### Rolling (S3) and Electrode Preparing (S4)

The mixture, which is in the clay-like status, obtained through the above step may be rolled to form the electrode film. The rolling in the present step may be performed through a typical film forming process.

More specifically, the rolling may be performed using a primary roller and a secondary roller. The roll speed ratio of the primary roller may range from 1:0.05 to 1:5, and the roll speed ratio of the secondary roller may range from 1:5 to 1:15. In addition, a stretching speed in the S3 may be at most 20 mm/min. Preferably, the stretching speed may range from 5 mm/min to 15 mm/min. In addition, the S3 may be performed in the range of the temperature in which the pyrolysis of the binder is not made. The more detailed temperature range may be varied depending on the type of the binder. For example, the temperature range may be at most 200° C., at most 180° C., at most 150° C., or at most 120° C.

The electrode film formed through the above step may be bound with a current collector to manufacture an electrode in a final stage.

The current collector provides the electric conductivity for the electrode while serving as a base to support the electrode film. Accordingly, the current collector needs to include a material having conductivity and durability at a specific level or more.

More specifically, the current collector may include various materials depending on whether the electrode is a positive electrode or a negative electrode. For example, the current collector may include iron, copper, stainless steel, aluminum, nickel, titanium, calcined carbon, copper or stainless steel, or those materials surface-treated with carbon, nickel, titanium, or silver, etc., and/or an alloy thereof. In addition, the current collector may have the form of a film, sheet, foil, net, porous body, foam, or nonwoven fabric to uniformly form an electrode active material layer on the surface of the current collector.

The thickness of the electrode film formed through the above step may range from 50 μm to 400 μm. Preferably, the thickness of the electrode film may range from 70 μm to 250 μm. In addition, the thickness of the current collector may range from 5 μm to 20 μm. Preferably, the thickness of the current collector may range from 7 μm to 18 μm. When the thickness of the electrode film and the current collector is in the above-described range, the electrode may exhibit excellent durability and performance with more balance.

The electrode manufactured through the manufacturing method of the present disclosure may be a positive electrode or a negative electrode. Preferably, the electrode may be the positive electrode.

### Electrode Free Standing Membrane

The present disclosure provides an electrode free standing membrane prepared in the manufacturing method of the electrode for the all-solid state battery described above.

More specifically, the present disclosure provides an electrode free standing membrane including an electrode active material complex including an electrode active material and a solid electrolyte, a binder, and a conductive material, in which the ratio (D2/D1) between the average particle size (D1) of the electrode active material complex and the average particle size D2 of the binder is at most 20.

The description about the electrode active material complex, the binder, and the conductive material included in the electrode free standing membrane will be the same as the above description about the electrode active material complex, the binder, and the conductive material.

More specifically, for the electrode free standing membrane according to the present disclosure, the electrode active material complex is prepared by coating the solid electrolyte shell on the electrode active material core, in which the ratio (b/a) between the diameter (a) of the electrode active material core and the thickness (b) of the solid electrolyte shell may be in the range of 0.05 to 0.5.

The electrode free standing membrane may be a positive electrode free standing membrane or a negative electrode free standing membrane. Preferably, the electrode free standing membrane may be the positive electrode free standing membrane.

### Electrode

The present disclosure provides an electrode including the electrode free standing membrane described above.

More specifically, the present disclosure provides an electrode including the electrode free standing membrane and the current collector. The electrode free standing membrane and the current collector may be bound with each other. The electrode free standing membrane may be coated on at least one surface of the current collector. The electrode may be a positive electrode or a negative electrode. Preferably, the electrode may be the positive electrode.

### All-Solid State Battery

The present disclosure provides an all-solid state battery including the electrode. More specifically, the present disclosure provides an all-solid state battery including the electrode, an opposite electrode, and a solid electrolyte layer interposed between the electrode and the opposite electrode. The opposite electrode refers to an electrode opposite to the electrode according to the present disclosure. When the electrode according to the present disclosure is a positive electrode, the opposite electrode may be a negative electrode. When the electrode according to the present disclosure is a negative electrode, the opposite electrode may be a positive electrode.

A solid electrolyte included in the solid electrolyte layer may be applied with the same solid electrolyte contained in the electrode active material complex.

Hereinafter, the present disclosure will be described in more detail according to embodiments. The following embodiments are provided only for the illustrative purpose of the present disclosure, and the scope of the present disclosure is not limited thereto.

### Material

An NCM-based positive electrode active material having the average particle size of 5 μm was used as the positive electrode active material. A sulfide-based solid electrolyte having the average particle size of 1 μm was used as a solid electrolyte. Polytetrafluoroethylene having the average particle size of 120 μm was used as the binder. Carbon black (Super C65) was used as the conductive material.

### EMBODIMENT 1

The positive electrode active material and the solid electrolyte particles of the material were mixed with each other without a solvent in advance in a ball mill machine, thereby preparing a positive electrode active material complex formed by coating the solid electrolyte on the surface of the positive electrode active material. The value of ‘b’/a′ for the positive electrode active material complex prepared was 0.3. The positive electrode active material complex was mixed with the conductive material of the material in the ball mill machine afterward, and the binder of the material is added and mixed. The mixing was performed such that the proportion of the positive electrode active material was 85 wt %, the proportion of the solid electrolyte is 13 wt %, and the proportion of each of the conductive material and the binder is 1 wt %, based on the sum of the weight of the positive electrode active material, the solid electrolyte, the conductive material, and the binder. In this case, the ratio (D2/D1) between the average particle size (D1) of the electrode active material complex and the average particle size (D2) of the binder was 18.5.

After the needing process was performed for the mixture to change the mixture to be in the clay-like status, the electrode film was formed through the primary roller and the secondary roller. The speed ratio of the primary roller and the speed ratio of the secondary roller were made to be 1:5 and 1:10, respectively. The temperature in the film forming process was maintained to 80° C. while the stretching speed was 10 mm/min.

After the electrode film was formed, the thickness of the electrode film was 100 μm, and the thickness of the prepared electrode film was bounded with the current collector having the thickness of 15 μm, thereby preparing the positive electrode for the all-solid state battery.

### EMBODIMENT 2

The positive electrode for the all-solid state battery was prepared in the same manner as Embodiment 1, except that the time to mix the positive electrode active material and the solid electrolyte particle was increased such that the value of ‘b/a’ becomes 0.75 and the ratio (D2/D1) between the average particle size (D1) of the electrode active material complex and the average particle size (D2) of the binder was made to be 13.7.

### Comparative Example 1

The electrode film was formed through the same process as that in Embodiment 1, after mixing the positive electrode active material, the solid electrolyte, the binder, and the conductive material with each other at the same ratio as that of Embodiment 1, without preparing the positive electrode active material complex in advance, which is different from Embodiment 1.

However, according to Comparative example 1, as the content of the binder is reduced, the film forming process was not smoothly performed. Accordingly, the electrode film failed to be formed.

### Comparative Example 2

The positive electrode for the all-solid state battery was prepared in the same manner as Embodiment 1, except that the time to mix the positive electrode active material and the solid electrolyte particle was decreased such that the value of ‘b/a’ becomes 0.05 and the ratio (D2/D1) between the average particle size (D1) of the electrode active material complex and the average particle size (D2) of the binder was made to be 22.9.

### Experimental Example 1: Observe Whether Binder Coagulated

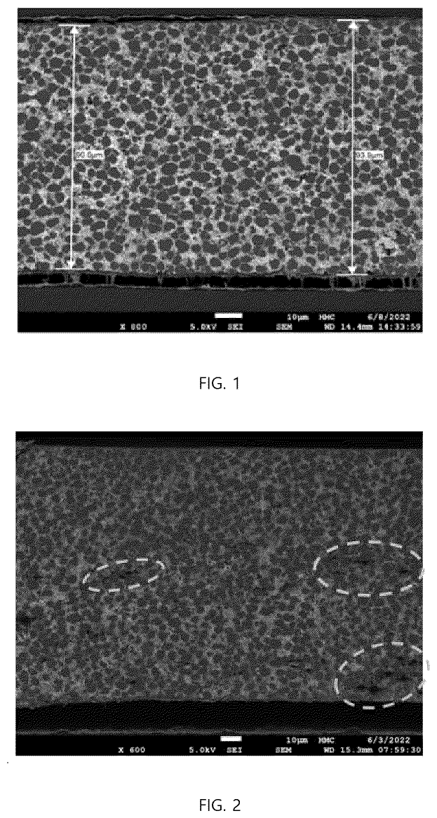

It was determined through, the SEM image, whether the coagulating phenomenon of the binder was improved in the electrode film prepared in Embodiment 1 and Comparative example 2. JEOL's JSM-7610FPlus was used as SEM equipment. The result of Embodiment 1 was shown in FIG. 1, and the result of Comparative example 2 was shown in FIG. 2.

As recognized from the results of FIGS. 1 and 2, according to the method for manufacturing the electrode of the present disclosure, as the positive electrode active material complex was formed in advance, the coagulating phenomenon of the binder was improved. In particular, it was recognized that the phenomenon of coagulating the binder was more improved in Embodiment 1 in which the solid electrolyte was coated with a thicker thickness rather than that of Comparative example 2 in which the value of ‘D2/D1’ exceeds ‘20’. Accordingly, it was recognized that the performance of the prepared electrode was more optimized, depending on the value of ‘b/a’ of the electrode active material complex prepared during the manufacturing process and the ratio in particle size between the electrode active material complex and the binder.

### Experimental Example 2: Initial Performance Determined

Cell performance in an initial stage was determined by utilizing the electrodes manufactured in Embodiments 1 and 2, and Comparative example 2. The detailed method for measuring the cell performance in the initial stage will be described below.
1) Specific charge capacity and specific discharge capacity: the electrode was punched with the size of 15 pi and placed at a lower layer of a pressed cell, 0.2 g of sulfide-based solid electrolyte powders was introduced into one surface of the electrode, and the result structure was pressing-molded. A lithium foil was attached to an opposite surface of the solid electrolyte layer to form the negative electrode layer, and charging and discharging experiments were performed with respect to the completed all-solid state battery at the C-rate of 0.1 C in the section ranging from 3.0 V to 4.3 V vs Li to measure the specific charge capacity and the specific discharge capacity.
2) Coulombic Efficiency: was calculated by dividing the specific discharge capacity, which was measured above, by the specific charge capacity, and by multiplying the result by 100%.
3) DC-IR: was measured at a second cycle in the charging/discharging experiment.

The result measured in the above process was summarized as shown in table 1.

TABLE 1

| | Specific | Specific | | |
|---|---|---|---|---|
| | charge | discharge | Coulombic | |
| | capacity | capacity | Efficiency | DC-IR |
| | (mAh/g) | (mAh/g | (%) | (Ω) |
| Comparative | 189.5 | 156.9 | 83 | 19.7 |
| example 2 | | | | |
| Embodiment 1 | 223.8 | 195.8 | 87 | 13.59 |
| Embodiment 2 | 206.3 | 175.07 | 85 | 13.91 |

It was recognized through the result as shown in Table 1, that the electrode having the excellent performance was manufactured through the method for manufacturing the electrode according to the present disclosure. More specifically, it was recognized that the performance of the electrode was more optimized, based on the value of ‘b/a’ in the electrode active material complex formed in the manufacturing process and the ratio in the particle size between the electrode active material complex and the binder. In particular, according to Comparative example 2, in which the value of ‘D2/D1’ exceeds 20, the specific charge/discharge capacity is more decreased, as compared as those of embodiments, and even DC-IR is higher than those of embodiments. Accordingly, the performance may be degraded as compared to the embodiments.

### Experimental Example 3: Electron Conductivity of Electrode and Ion Conductivity of Electrode Determined

The electron conductivity and the ion conductivity were determined with respect to the electrodes manufactured in Embodiment 1 and Comparative example 2. The ion conductivity and the electron conductivity were measured through the following manner.

1) Manner for measuring ion conductivity and electron conductivity: One sheet of a current collector was placed on the mixture of the manufactured electrode, and the result was pressing-molded. Accordingly, a mold (having the diameter of 13 mm) for measuring was produced, AC potential of 10 mV was applied to the mold, and the frequency swap from 3 MHz to 1 kHz was performed to measure the impedance value. The ion conductivity and the electron conductivity were calculated, based on the measured impedance value.

The measurement result was summarized as shown in Table 2.

TABLE 2

| | Electron conductivity | Ion conductivity |
|---|---|---|
| | (mS/cm) | (ms/cm) |
| Comparative example 2 | 0.01 | 0.01 |
| Embodiment 1 | 0.01 | 0.03 |

As shown in table 2, the electrode manufactured through the method for manufacturing the electrode according to the present disclosure sufficiently shows the electron conductivity and the ion conductivity. The performance of the electrode prepared may be more optimized, depending on the value of ‘b/a’ in the electrode active material complex, which was prepared in the manufacturing process, and the ratio in the particle size between the electrode active material complex and the binder.

In the method for manufacturing the electrode for the all-solid state battery, the electrode active material complex is first prepared by using the solid electrolyte and the electrode active material, thereby reducing the difference in particle size between the electrode active material and the binder particle, such that the uniformity of inter-particle shear stress applied during the needing process is improved. Accordingly, the uniformity of the electrode manufactured in the final stage may be enhanced.

In addition, in the method for manufacturing the electrode for the all-solid state battery of the present disclosure, the electrode is manufactured in the dry-manufacturing manner while the usage of the binder is lowered to the level used in the wet-manufacturing manner. Accordingly, the electrode for the all-solid state battery having more excellent performance may be manufactured at lower costs.

In addition, according to the present disclosure, the electrode free standing membrane, the electrode, and the all-solid state battery including the same may exhibit excellent performance and excellent durability, as the electrode exhibits excellent uniformity.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing an electrode for an all-solid state battery, the method comprising:
mixing an electrode active material with a solid electrolyte to prepare an electrode active material complex (S1);
mixing the electrode active material complex, a conductive material, and a binder to prepare a mixture (S2);
rolling the mixture in a clay status to form an electrode film (S3); and
binding a current collector with the electrode film (S4),
wherein a ratio (D2/D1) between an average particle size (D2) of the binder and an average particle size (D1) of the electrode active material complex is at most about 20.

2. The method of claim 1, wherein the electrode active material complex is prepared by coating a solid electrolyte shell on an electrode active material core, and
wherein a ratio (b/a) between a diameter (a) of the electrode active material core and a thickness (b) of the solid electrolyte shell ranges from about 0.05 to 0.5.

3. The method of claim 1, wherein an average particle size of the electrode active material ranges from about 1 μm to 50 μm.

4. The method of claim 1, wherein an average particle size of the solid electrolyte ranges from about 0.01 μm to 20 μm.

5. The method of claim 1, wherein an average particle size of the binder is at most about 500 μm.

6. The method of claim 1, wherein the binder comprises polytetrafluoroethylene (PTFE) or polyvinylidene fluoride-hexapropylene (PVDF-HFP) copolymer.

7. The method of claim 1, wherein a content of the binder in the electrode is at most about 5 wt %.

8. The method of claim 1, wherein the S1 and the S2 are performed in absence of a solvent.

9. The method of claim 1, wherein the S2 further comprises:
performing a needing process to change the mixture to be in the clay status.

10. The method of claim 1, wherein the rolling process is performed using a primary roller and a secondary roller.

11. The method of claim 10, wherein a roll speed ratio of the primary roller ranges from about 1:0.05 to 1:5.

12. The method of claim 10, wherein a roll speed ratio of the secondary roller ranges from about 1:5 to 1:15.

13. The method of claim 1, wherein a stretching speed in the S3 is at most about 20 mm/min.

14. The method of claim 1, wherein the S3 is performed at a temperature ranging from about 50° C. to 90° C.

15. The method of claim 1, wherein the electrode is a positive electrode.

16. An electrode free standing membrane comprising:
an electrode active material complex comprising:
an electrode active material core and
a solid electrolyte on the electrode active material core;
a binder, and
a conductive material,
wherein a ratio (b/a) between a diameter (a) of the electrode active material core and a thickness (b) of the solid electrolyte shell ranges from about 0.05 to 0.5.

17. An electrode free standing membrane comprising:
an electrode active material complex comprising an electrode active material and a solid electrolyte;
a binder, and
a conductive material,
wherein a ratio (D2/D1) between an average particle size (D1) of the electrode active material complex and an average particle size (D2) of the binder is at most about 20.

18. The electrode free standing membrane of claim 17, wherein the electrode active material complex is prepared by coating a solid electrolyte shell on an electrode active material core, and
wherein a ratio (b/a) between a diameter (a) of the electrode active material core and a thickness (b) of the solid electrolyte shell ranges from about 0.05 to 0.5.

19. An electrode comprising:
the electrode free standing membrane according to claim 16; and
a current collector.

20. An all-solid state battery comprising:
the electrode according to claim 19;
an opposite electrode; and
a solid electrolyte layer interposed between the electrode and the opposite electrode.
